(19) United States
(12) Patent Application Publication
(10) Pub. No.: US 2018/0255429 A1
(43) Pub. Date: Sep. 6, 2018

(54) USING BACKGROUND AUDIO SIGNALS TO DETECT LOCATIONS

(71) Applicant: Amazon Technologies, Inc., Seattle, WA (US)

(72) Inventors: William R. Hazlewood, Seattle, WA (US); Neeresh Padmanabhan, Seattle, WA (US)

(21) Appl. No.: 15/448,464

(22) Filed: Mar. 2, 2017

(51) Int. Cl. H04W 4/02; G10L 25/51

(52) U.S. Cl. CPC H04W 4/023; G10L 25/51

(57) ABSTRACT

Techniques for determining a location of a user device may be provided. For example, the location of the user device may be determined using various method described herein, including methods related to audio analysis, positioning systems, data received through a plurality of communication protocols, and/or signal analysis.

### BACKGROUND

It has become common for a mobile device such as a mobile phone to have facilities for determining the location of the device and for providing the location to various end-user applications (“apps”). However, the location of the device may be inaccurate or unknown due to network interference, limitations with current positioning systems, or other instances when the user device is not providing an accurate location to the network (e.g., opting out of one or more location determination services, on a network that limits the accessibility of the device location based on limited information in a data packet header, etc.). As one illustration, the device may be adjacent to tall buildings that obstructs network communications between the device and cellular network tower, which can transmit radio waves to communicate with other towers or to the network. The tall buildings may block a radio signal between the cellular tower and the user device or create a coverage gap in an area where there is minimal to no overlap between the cell towers. The user device can be degraded in such areas. The same problem may occur when the device is underground or in a building that can block radio waves.

### BRIEF DESCRIPTION OF THE DRAWINGS

Various embodiments in accordance with the present disclosure will be described with reference to the drawings, in which:

FIG. 1 illustrates an illustrative flow for determining location data based on audio described herein, according to at least one example;

FIG. 2 illustrates an example architecture for determining location data based on audio described herein that includes a location computer, cellular base station, and/or a user device connected via one or more networks, according to at least one example;

FIG. 3 illustrates an illustrative flow for revising audio for broadcast described herein, according to at least one example;

FIG. 4 illustrates an illustrative flow for associating audio with a location described herein, according to at least one example;

FIG. 5 illustrates an illustrative flow for correlating data described herein, according to at least one example;

FIG. 6 illustrates an illustrative flow for determining location data associated with one or more cellular base stations described herein, according to at least one example;

FIG. 7 illustrates an illustrative flow for determining location data described herein, according to at least one example;

FIG. 8 illustrates an illustrative flow for determining location data described herein, according to at least one example;

FIG. 9 illustrates an example flow diagram for determining location data based on audio described herein, according to at least one example;

FIG. 10 illustrates an example flow diagram for determining location data based on audio described herein, according to at least one example;

FIG. 11 illustrates an example flow diagram for determining location data based on audio described herein, according to at least one example;

FIG. 12 illustrates an example flow diagram for determining location data based on audio described herein, according to at least one example;

FIG. 13 illustrates an example flow diagram for determining location data based on audio described herein, according to at least one example; and

FIG. 14 illustrates an environment in which various embodiments can be implemented.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Embodiments of the present disclosure are directed to, among other things, a system and method for determining a location of a user based at least in part on data from a microphone of a device associated with the user. For example, a computing system can receive data (e.g., an audio stream, etc.) based on a signal generated by a microphone of a mobile device that corresponds to audio (e.g., sound waves, etc.). The audio may be generated by a speaker at a location during an interval of time. The audio broadcast at the location may comprise an audio component that is unique to the location. The computing system can identify the audio component based on the received data and determine a location of the mobile device based at least in part on the identified audio component that is unique to the location. The computing system may provide the location of the mobile device to the mobile device or other computing system.

In another embodiment of the present disclosure, a computing system can receive first data based on a first signal generated by a first microphone. The location of the first microphone may be a known location during an interval of time. The computing system can receive second data based on a second signal generated by a second microphone. The second microphone may correspond with a mobile device during the interval of time and, in some examples, the location of the mobile device may be unknown during the interval of time (e.g., when the second signal is received by the computing system, etc.). The computing system can compare the first data with the second data and determine, based on the comparing, that the mobile device is at the location of the first microphone. The computing system may provide the location of the mobile device to the mobile device or other computing system.

In an illustrative example of these two embodiments, a user downloads an application to their user device and enters a brick-and-mortar building with the user device. The user device may be enabled to send and receive data packets (e.g., browse to a shared network, receive streaming data, etc.) through the application, but may not enabled to provide a location of the mobile device to other systems (e.g., location services are inoperable, opt-out of providing global positioning system (GPS) data, or the location determination service may be degraded and/or inaccurate, etc.). Once the user enters the building (e.g., at a known location that may be static or dynamic over time, etc.), the microphone integrated with the user device may be activated (e.g., by a voice command, by a trigger associated with the location, etc.). The microphone may receive audio throughout the building, including audio that is broadcast within the building (e.g., songs from a radio, unique audio components that are broadcast with the songs via speakers within the building, etc.), background audio noise (e.g., fire engine sirens, ringing clock bells, conversations of other users not associated with the user device, etc.), an audio command from a user speaking into the microphone, or other audio sources. The audio received by the microphone of the user device may be transmitted to a computing system. Other audio sources may be transmitted to the computing system as well, including data from the brick-and-mortar building, data from other user devices within the brick-and-mortar building, and the like.

The audio data from the building may comprise various audio. For example, the audio data from the building may comprise generic audio data (e.g., a song played from a broadcast radio station that is provided through a speaker in the building, etc.) as well as unique audio data (e.g., an unique signal that is inaudible to human hearing and also transmitted through the speaker in the building, or an unique signal similar to a dog whistle, etc.). In some examples, the unique audio data may correspond with particular locations within the building (e.g., unique audio signal A corresponding with the right-side of the building and unique audio signal B corresponding with the left-side of the building, etc.). The audio data from building, in some examples, may comprise background noise that may be unique to the building, but not associated with a transmission provided by the building (e.g., a siren next to the perimeter of the building, white noise only heard inside the building, etc.).

The computing system can receive the sources of audio and compare them. In some examples, both audio sources are received by the same microphone and transmitted to the computing system (e.g., broadcast audio data and the unique audio segment broadcast inside the building, etc.). The computing system can identify at least some of the portions of audio from a single audio data packet by comparing the received audio data (e.g., from the user device, etc.) with stored audio data (e.g., when the computing system broadcasts a song and the building provides the song through speakers within the building, which is received by the user device while the user device is in the building, etc.). When the two audio data sources are compared and they match, the computing system may determine that the user device is at or around the location of the building, based at least in part on the comparison.

In another embodiment of the present disclosure, a mobile telephone and information server may implement various processes described herein, including various processes based on one or more operating systems associated with the mobile telephone. For example, in one type of operating system installed at the mobile telephone, the mobile telephone may establish a communication connection to a cellular base station in accordance with a telecommunication protocol. The mobile telephone may receive, with an application programming interface of the mobile telephone, an identifier of the cellular base station, and send the identifier of the cellular base station to a location information server in accordance with an internet protocol. The mobile telephone may then receive a location of the cellular base station from the location information server based at least in part on the identifier of the cellar base station.

In an illustrative example of this embodiment, a user enters a brick-and-mortar building with a user device. Again, the user device may be enabled to send and receive data packets (e.g., browse to a shared network, receive streaming data, etc.), but may not enabled to provide a location of the mobile device to other systems (e.g., location services are inoperable, opt-out of providing global positioning system (GPS) data, etc.). Determining a location of the mobile device may rely on data generated or received from performing one or more interactions between the mobile device and a base station. For example, the mobile device may rely on an installed operating system that allows the mobile device to view base station information and/or rank the strength of communication connections to the various base stations that the mobile device is able to ping within a range. When the strongest signal is identified from a particular base station, an application module on the mobile device may retrieve the base station's identifier and generate a message with the base station identifier. Since the base stations were ranked, the strongest signal may signify that the mobile device was the closest to the particular base station at the time when the mobile device received the identifier. The base station identifier may also be stored with a backend server, so that when the mobile device transmits the base station identifier to the backend server, the server can identify the location of the mobile device as adjacent or close to the base station.

In another embodiment, where a second type of operating system is installed at the mobile telephone, the mobile telephone may establish a first communication connection to a cellular base station in accordance with a telecommunication protocol and a second communication connection to a location information server in accordance with an internet protocol. The second communication connection may be implemented at least in part with the first communication connection and the cellular base station may cause a message to be sent over the second communication connection to indicate an identifier of the cellular base station (e.g., wrapping or tagging the message, etc.). The mobile telephone in this example may then receive, over the second communication connection, a location of the cellular base station from the location information server based at least in part on the identifier of the cellar base station.

In an illustrative example of this embodiment, a user enters a brick-and-mortar building with a user device. Again, the user device may be enabled to send and receive data packets (e.g., browse to a shared network, receive streaming data, etc.), but may not enabled to provide a location of the mobile device to other systems (e.g., location services are inoperable, opt-out of providing global positioning system (GPS) data, etc.). Determining a location of the mobile device in this instance may rely on an installed operating system that does not allow the mobile device to view base station information and/or rank the strength of communication connections to the various base stations. Rather, the mobile device may communicate with the strongest signal from a particular base station without ranking or triangulating the signals. The mobile device may establish a communication with the particular base station, which wraps or tags the message from the mobile device with its base station identifier, and the base station may transmit the wrapped or tagged message to the backend server. Again, the base station identifier may also be stored with a backend server, so that when the server receives the base station identifier in the message, the server can identify the location of the mobile device as adjacent or close to the base station that wrapped or tagged the message.

Embodiments of the disclosure solve several technical problems using various technical solutions. For example, as discussed in the background of the application, a location of a user device may be the location of the device may be inaccurate or unknown due to network interference, limitations with current positioning systems, or other instances when the user device is not providing an accurate location to the network (e.g., opting out of one or more location determination services, on a network that limits the accessibility of the device location based on limited information in a data packet header, etc.). As one illustration, the device may be adjacent to tall buildings that obstructs network communications between the device and cellular network tower, which can transmit radio waves to communicate with other towers or to the network. The tall buildings may block a radio signal between the cellular tower and the user device or create a coverage gap in an area where there is minimal to no overlap between the cell towers. The user device can be degraded in such areas. The same problem may occur when the device is underground or in a building that can block radio waves.

Embodiments of the disclosure may solve these technical problems related to coverage areas and location determinations by not relying on positioning systems and instead relying on an analysis of other data around the user device using technology available to the user device, in new and inventive ways. For example, a computer system can receive data that corresponds with audio generated by a speaker at a location and identify audio components from the data. One audio component may be unique to a particular location (e.g., an inaudible sound that is broadcast with a generic sound, a combination of conversation and environmental noise that is recorded from the location, etc.). The computer system can identify that unique sound as coming from a particular location and, based on that identification, determine that the device that recorded and transmitted the sound to the computer system is also at the particular location. This example may not rely on location services or an internal positioning system associated with the mobile device, but rather audio analysis (e.g., digital “fingerprints,” frequency or spectrum comparison, etc.).

In another example that illustrates the technical solutions to this technical problem, the computer system can receive a message from a mobile device that has been encoded with information associated to one or more cellular base stations that the mobile device has communicated or connected with (e.g., handshake, a full registration process with the base station, etc.). In some embodiments, the mobile device may receive a base station identifier from the cellular base station after the initial communication with the base station. The mobile device can send this identifier to the computer system, and the computer system can identify that the mobile device is within a communication range or distance of the cellular base station, based at least in part on merely receiving the identifier from the cellular base station.

In another example that illustrates the technical solutions to this technical problem, the mobile device may limit the access to the cellular base station information through an operating system installed with the mobile device. In this instance, the mobile device can initiate the communication with the cellular base station and the cellular base station can include its identifier with a message that the mobile device transmits to the computer system via the cellular base station. This may include wrapping the message with an additional header or tagging the message, each of which may add the base station identifier to the message. When the computer system receives the revised message, the computer system can determine the origin of the message (e.g., the mobile device, etc.) and the cellular base station, based at least in part on the header.

Various benefits may be realized from embodiments described herein. For example, by wrapping the message with a header or tagging the message, the mobile device and/or computer system may limit communication and increase efficiency. Additionally, the computer system may be prevented from needing to continuously ping the location of the user device, but rather analyze data packets transmitted to and from the user device, cellular towers, and other devices to determine the location of the user device.

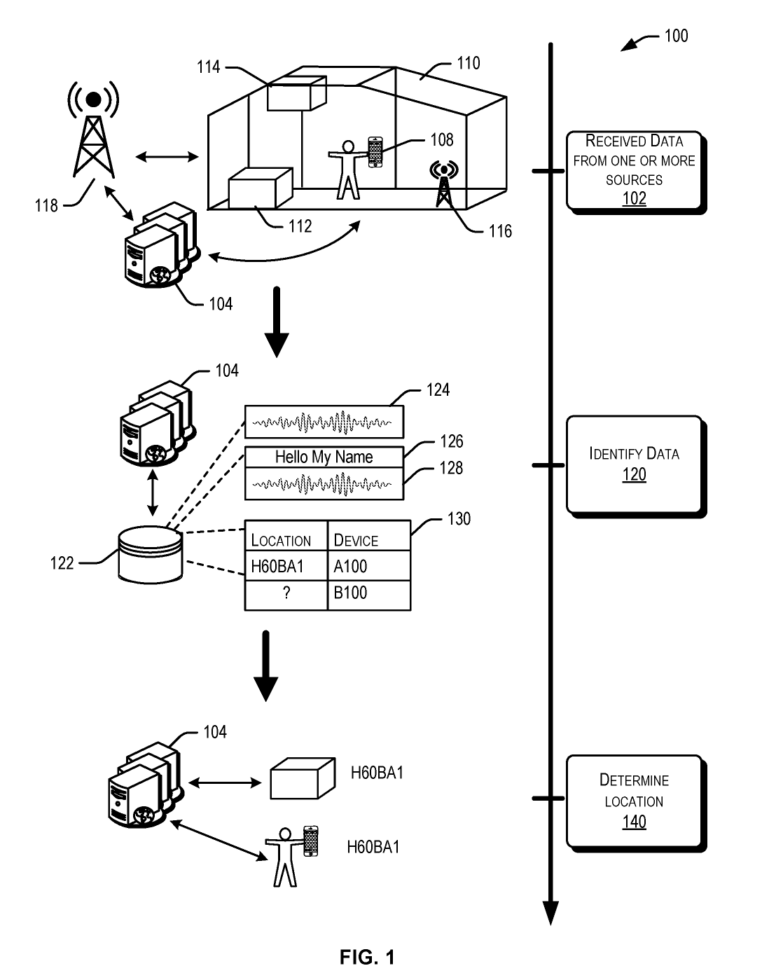

FIG. 1 illustrates an illustrative flow for determining a location of a user device described herein, according to at least one example. Various methods and systems may be discussed herein, including determining a location of a mobile device 108 using audio signals or determining the location of the mobile device 108 using data corresponding with communication connections via various communication protocols. The methods and systems are discussed in FIG. 1 and throughout the application. As used herein, the “location” of a user device corresponds to a region, such as a volume of space, within which the device is likely to reside.

For example, the location may correspond to a sphere or circle around a particular set of geophysical coordinates, a building, a room within a building, and/or a portion of a room within a building.

The process 100 can begin with receiving data from one or more sources at 102. For example, a computer system 104 may receive data from various sources, including a user device 108 that produces or captures data, a resource provider building 110 associated with providing data, one or more microphones 112 that capture data or audio signals, one or more speakers 114 that transmit audio data associated with the resource provider building 110, and/or other sources of data. The data may comprise one or more data packets or audio signals received at the computer system 104 and stored with a data store 122. Other sources of audio and data may be received without diverting from the scope of the disclosure.

The user device 108 may enter a resource provider building 110 and record audio from one or more sources within the building. For example, the resource provider building 110 may broadcast music through one or more speakers 114 that the resource provider building 110 receives from an independent location (e.g., a radio station, a recorded disc or computer of music that is played by the resource provider building 110 through the one or more speakers 114, etc.). The audio may comprise broadcast music, the unique audio signal, environmental audio, a command from the user associated with the app, any relevant location data that is available, or other data. The unique audio signal may be designed to be easy to distinguish from broadcast music, environmental audio, etc. For example, the unique audio signal may be located in otherwise relatively quiet and/or predictable portions of the audio spectrum including ultrasonic and infrasonic portions of the audio spectrum. As another example, the unique audio signal may be clearly distinguishable from natural audio signals by having one or more characteristics that are unlikely to be generated by natural means, such as audio signals with sharp transitions such as audio signals with square or triangle waveforms. The unique audio signals may be unique with respect to one another based on any suitable audio signal characteristic including frequency, waveform, and codes embedded in and/or created with audio signal frequencies and waveforms.

Speakers 114 within the resource provider building 110 may broadcast the audio. For example, the resource provider building 110 may receive an electrical current (e.g., of an audio data transmission, etc.) from the independent source. The one or more speakers 114 (e.g., using an electromagnet, permanent magnet, amplifier, etc.) may transmit the received data as audio to a location associated with the speakers 114 (e.g., the resource provider building 110, etc.).

In some examples, music or announcements are played through the speakers 114. For example, the audio provided through the speakers 114 may be music selected to be played during an interval of time at a limited set of locations including the resource provider building 110. The music may be used to identify the resource provider building 110 because of the particular music played at a particular interval of time. In some examples, the music is provided from an independent computer system that is not unique to the resource provider building 110.

In some examples, one or more speakers 114 may provide different music in different parts of the resource provider building 110, including sublocations of the building. For example, the audio provided through a subset of the one or more speakers 114 may comprise a first audio component that is unique to the sublocation (e.g., the left side of the building, etc.) and a second audio component that is unique to the sublocation (e.g., the right side of the building, etc.). A plurality of sublocations may be identified and unique audio components may be generated for each of the sublocations so that each of the unique audio components correspond to the sublocations.

In some examples, the one or more speakers 114 provide a unique audio signal in addition to the generic audio from the independent location. This may include a high-frequency audio signal that is unique to the resource provider building 110 and/or inaudible to human hearing. In some examples, the audio played from the recorded disc or computer may be unique because it is played at a particular time, even if the music is associated with a recorded disc is played in other locations (e.g., generic or not unique to the resource provider building 110 location, etc.).

In some examples, the resource provider building 110 may comprise a second computer system (e.g., at the resource provider building 110, accessible by the resource provider building 110, etc.). This second computer may encode the audio component that is unique to the location.

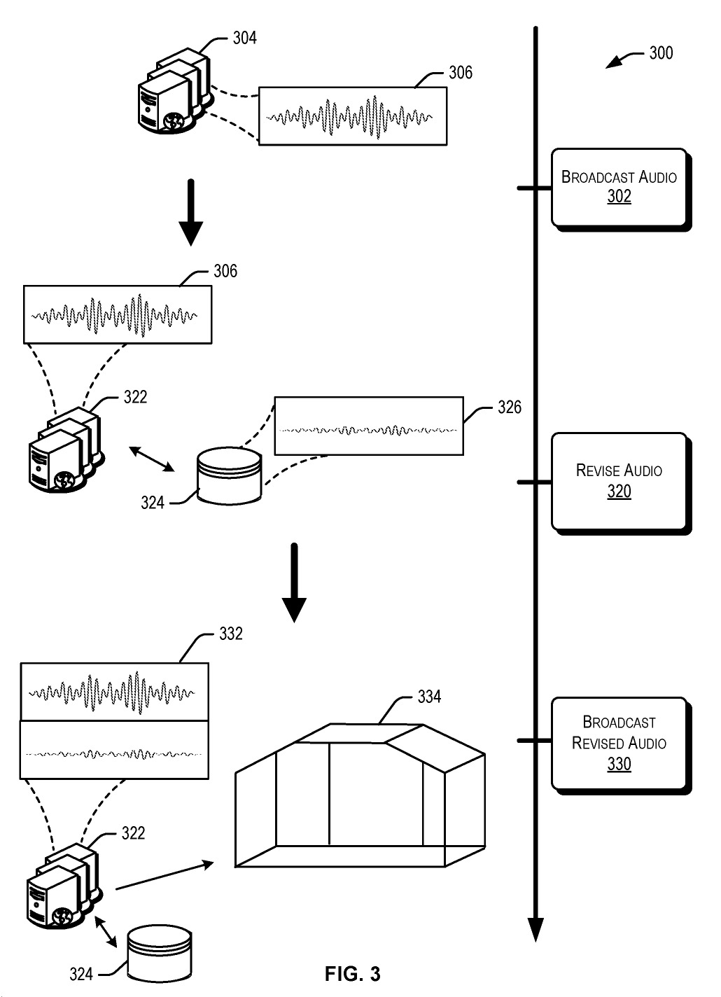

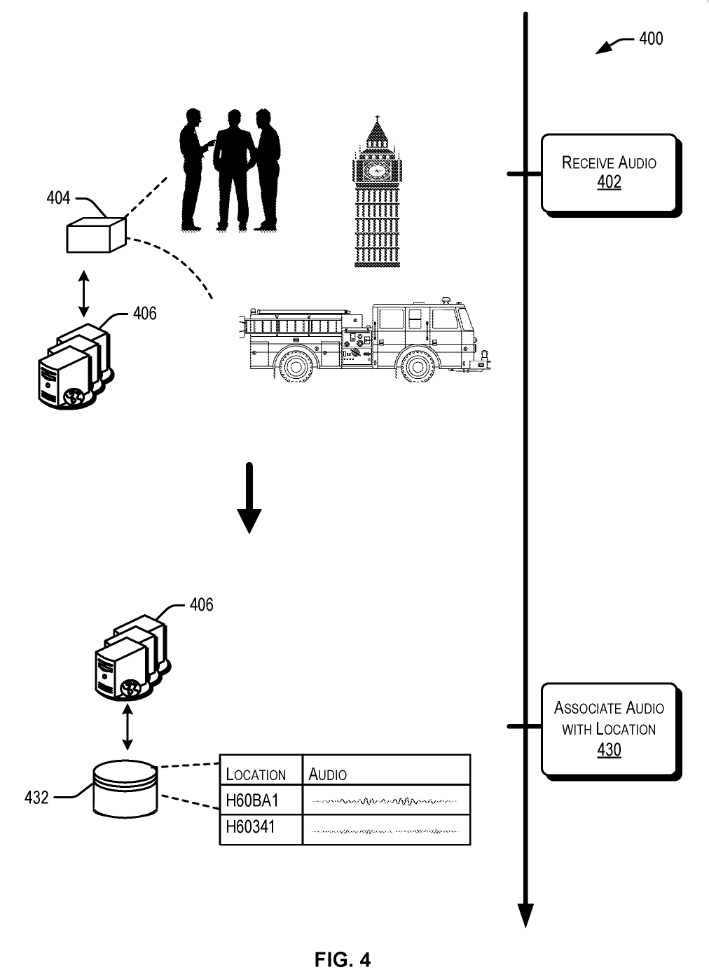

The audio component may be generated by the second computer at the resource provider building 110, by the one or more speakers 114 (e.g., in a continuous loop, etc.), or merely played and transmitted by the speakers from a secondary source (e.g., speakers, an audio generation unit, a speaker that speaks into a microphone that is transmitted via the speakers, etc.). Additional detailed associated with the broadcast and unique audio is described with FIGS. 3-4.

The user device 108 may activate a microphone included with the user device 108 while the device is in or around the resource provider building 110. For example, the user may activate an application module incorporated with the user device 108. The microphone may start recording after an application module is accessed at the mobile device for a different purpose than recording audio generated by the speaker at the location. The application module may activate the microphone and record a signal generated by the microphone of the user device 108 or stream audio to a computer system 104 from the user device 108 (e.g., for four seconds, etc.).

In some examples, the application module on the device 108 may analyze the audio broadcast to determine the audio component, rather than the computer system 104. The analysis by the user device 108 may be similar to the analysis conducted by the computer system 108 (e.g., comparing digital fingerprints, comparing values or coefficients, altering the data using a Fourier transform such as a Fast Fourier Transform or FFT, etc.). The application module on the device 108 may transmits the audio component to the computer system 108.

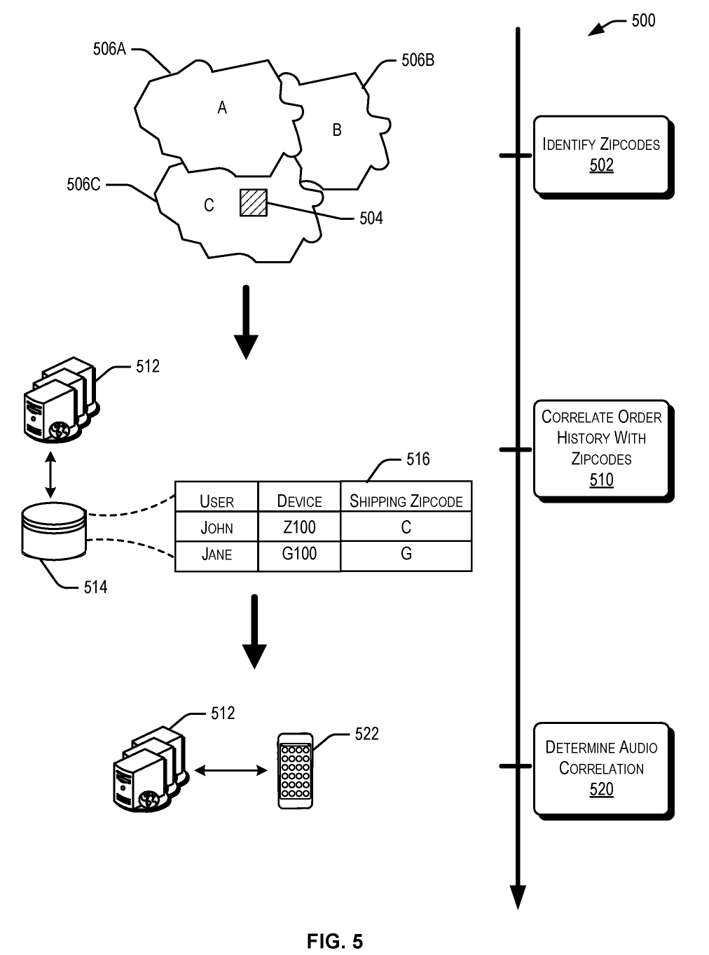

In some examples, the user device 108 may be identified from a plurality of user devices, as discussed with FIG. 5. For example, various user devices may be enabled to activate a microphone included with the user device 108, but only some of the user devices within a plurality of user devices may also record and/or transmit the audio from the device to the computer system 104. The microphone at the user device 108 may be activated and receive the broadcast music and/or unique audio signal transmitted by the speakers 114 when the user device 108 is selected from the plurality of user devices.

In some examples, the audio may be received at the computer system 104 from other sources as well. For example, the audio can be received through a microphone 112 associated with the resource provider building 110. The microphone 112 may be static or dynamic for an interval of time. In some examples, the resource provider building 110 may activate the one or more microphones 112 to record environmental audio from in or around the resource provider building 110. The transmission may also comprise location data associated with a static or dynamic location (e.g., determined by a positioning system (GPS) of the resource provider building 110 or one or more microphones 112, determined by stored latitude/longitude coordinates, etc.).

The audio data may be transmitted from the mobile device 108 and/or microphone 112 to the computer system 104. The computer system 104 may store the data in a data store 122. For example, the audio may be received as data that corresponds with the signal generated by the microphone of the mobile device 108 or the microphone in the resource provider building 110. The data may comprise an audio broadcast from the resource provider building 110 that is generic to the resource provider building 110 (e.g., broadcast at various buildings through a variety of frequencies, etc.), environmental audio from the resource provider building 110, and/or an audio component that is unique to the resource provider building 110.

In some examples, rather than audio, communication data may be received from a cellular base station 116 (e.g., within a resource provider building 110, a femtocell or picocell base station, etc.) and transmitted to the computer system 104. For example, the computer system 104 may receive data from various sources, including a user device 108 that interacts with the cellular base station 116 or from the cellular base station 116 itself. The data from the user device 108 may comprise a base station identifier from the cellular base station 116 (e.g., that the user device 108 prior to transmitting the data to the computer system 104, etc.).

The data from the cellular base station 116 may comprise the data from the user device 108 and the base station identifier that the cellular base station 116 adds to the original data from the user device 108 (e.g., that the user device 108 provided to the cellular base station 116 prior to the cellular base station 116 transmitted to the computer system 104, etc.). For example, the cellular base station 116 may receive a message from the user device 108, alter the message to include the base station identifier with the message, and transmit the altered message to the computer system 104 on behalf of the user device 108. The data may comprise one or more data packets or messages received at the computer system 104 and stored with a data store 122.

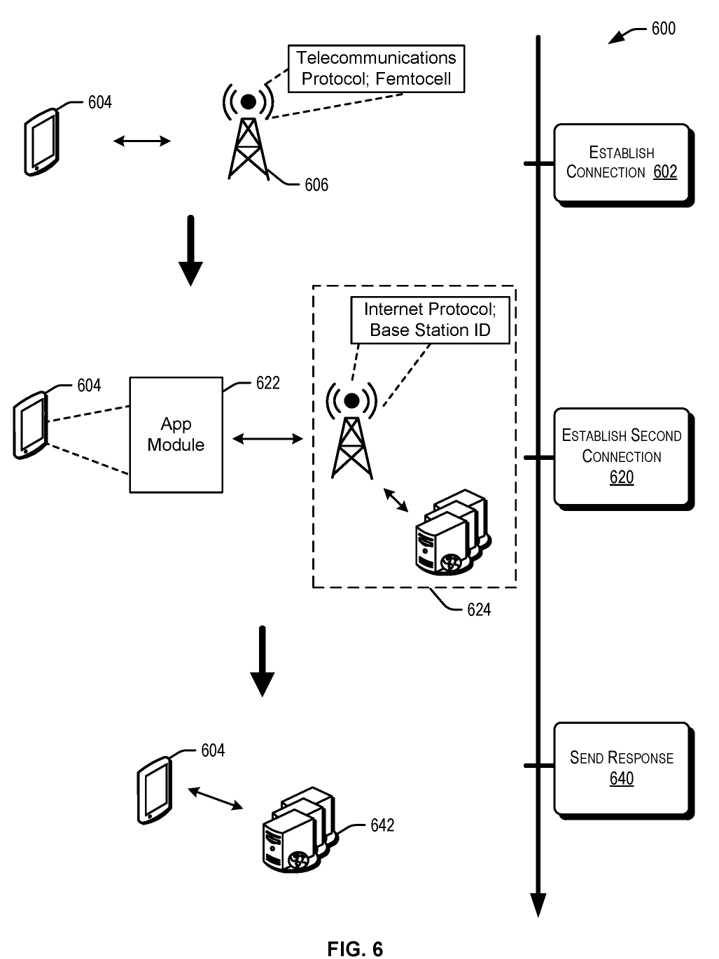

In some examples, the cellular base station 116 may communicate with a secondary base station 118 or wider network to provide data to the computer system 108. The cellular base station 116 and the secondary base station 118 may be distinguishable. For example, the secondary base station 118 may be a standard cell tower and the cellular base station 116 may be low power, limited area base stations. The cellular base station 116 may connect to a carrier over an internet connection or virtual private network (VPN). Other sources of data may be received without diverting from the scope of the disclosure. Additional details associated with these embodiments are discussed with FIGS. 6-8.

The process 100 may next identify data at 120. For example, the computer system 104 may receive the audio from the microphones (via one or more computers and communication networks, etc.) or data from the cellular base station 116. In either instance, the computer system 104 can identify this data or subparts of the data. The received data may be analyzed, compared, and/or stored in data store 122.

The stored data in the data store 122 may comprise various data. For example, the stored data in the data store 122 can comprise audio 124 from the microphone of the mobile device 108 or the microphone in the resource provider building 110, a command 126 and/or environmental audio 128 provided in a single data transmission, and/or location data 130 associated with static or dynamic locations that are known at a particular time. In some examples, the data store 122 may also comprise frequency specifications or other data identifiers for data that may be represented as analog or digital signals, and in the time or frequency domains for cellular base station 116, the secondary base station 118, or user device 108.

A Fourier transform may be applied in the frequency domain of the audio data (e.g., the first data and/or the second data, data from multiple sources, etc.). For example, a fast Fourier transform (FFT) may be implemented. During the analysis, the audio signal may be compared with sinusoids of various frequencies to obtain a magnitude coefficient of each data source. If the coefficient is large in comparison to a coefficient threshold, there may be a high similarity between the signal and the sinusoid and the signal may contain a periodic oscillation at that frequency. When two or more data sources are analyzed, this may determine that the data may be similar. If the coefficient is small in comparison to the coefficient threshold, there may be little to no similarity between the signal and the sinusoid, which can identify that the periodic oscillation is present at a different frequency. When two or more data sources are analyzed, this may determine that the data may not be similar.

The stored data that may be compared with the received data. The comparison may comprise various processes. For example, the comparison may comprise comparing a first audio signal from a user device 108 with a second audio signal from microphone 114 of the resource provider building 110. The process may also extract or identify portions of the audio, including a unique portion of the audio and a generic portion of the audio. For example, the data transmission may comprise a multiplexing process to combine multiple analog or digital signals into a single signal and transmitted via a network (e.g., cable, VPN, etc.). The computer system 104 may perform demultiplexing to extract or identify different audio portions, e.g., associated with different portions of an audio spectrum.

The comparison may comprise comparing representations of the audio or data as well. The audio may be received as a signal generated by a microphone, but the comparison may be based on representations of the signal. For example, the representation of the first audio component from the mobile device 108 may be compared with a representation of stored audio components from microphones of the resource provider building 110. In another example, the representation of the first audio component (e.g., a unique portion of the audio signal from the microphones of the resource provider building 110, etc.) may be compared with a representation of stored audio components (e.g., a generic portion of the audio signal from the microphones of the resource provider building 110, etc.).

The process 100 may also determine a location at 140. For example, the computer system 104 may determine a location of the mobile device based at least in part on the comparison between the first representation of the first audio component and the second representation of the stored audio components.

In some examples, the determination may be based at least in part on time. For example, the computer system 104 and/or speakers 114 may provide the audio to the resource provider building 110 at a particular time. When the particular time is associated with the interval of time that the audio is provided by the speaker at the location, the computer system 104 can determine that the location of the device 108 may be at the location of the speaker at the particular time.

In some examples, a score may help determine the location of the mobile device. For example, the computer system 104 may determine a value of the received data (e.g., using digital fingerprint analysis, by processing the data to form values that represent audio of the data, etc.). The computer system 104 may then compare the value of the received data with a confidence threshold (e.g., to determine the likelihood that the user device is at the resource provider building 110, etc.). A confidence score may be generated. This confidence score may be based at least in part on the comparison of the value of the received data and the confidence threshold.

The location of the user device 108 may correspond with a known location of a device including one or more speakers 114 or adjacent to one or more microphones 112. For example, when the audio component or representations of the audio components are within a threshold similarity of each other, the location corresponding with the mobile device that provided the first audio may be determined to be around the same known location as the second audio (e.g., from the resource provider building 110, from a secondary microphone, etc.).

The computer system 104 may provide the location of the mobile device to various devices, including to the mobile device that originated the transmission of the audio signal or data. In some examples, the location may be provided with additional information that is related to the known location (e.g., advertisements, offers, etc.).

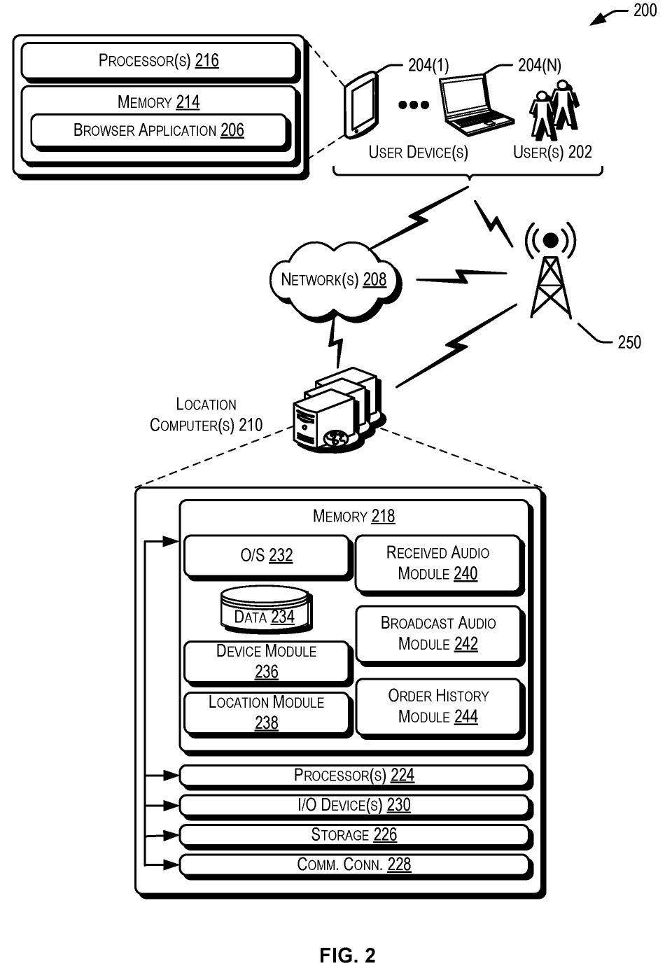

FIG. 2 illustrates an example architecture for determining a location of a user device described herein that includes a location management computer and/or a user device connected via one or more networks, according to at least one example. In architecture 200, one or more users 202 (i.e., web browser users) may utilize user computing devices 204(1)-(N) (collectively, user devices 204) to access an application 206 (e.g., a web browser), via one or more networks 208. In some aspects, the application 206 may be hosted, managed, and/or provided by a computing resources service or service provider, such as by utilizing one or more service provider computers and/or one or more location computers 210. The one or more location computers 210 may, in some examples, provide computing resources such as, but not limited to, client entities, low latency data storage, durable data storage, data access, management, virtualization, cloud-based software solutions, electronic content performance management, etc. The one or more location computers 210 may also be operable to provide web hosting, computer application development, and/or implementation platforms, combinations of the foregoing, or the like to the one or more users 202. The one or more location computers 210, in some examples, may help determine location data of one or more computing devices 204.

In some examples, the networks 208 may include any one or a combination of many different types of networks, such as cable networks, the Internet, wireless networks, cellular networks and other private and/or public networks. While the illustrated example represents the users 202 accessing the application 206 over the networks 208, the described techniques may equally apply in instances where the users 202 interact with the location computers 210 via the one or more user devices 204 over a landline phone, via a kiosk, or in any other manner. It is also noted that the described techniques may apply in other client/server arrangements (e.g., set-top boxes, etc.), as well as in non-client/server arrangements (e.g., locally stored applications, etc.).

As described briefly above, the application 206 may allow the users 202 to interact with a service provider computer, such as to access web content (e.g., web pages, music, video, etc.).

The one or more location computers 210, perhaps arranged in a cluster of servers or as a server farm, may host the application 206 and/or cloud-based software services. Other server architectures may also be used to host the application 206. The application 206 may be capable of handling requests from many users 202 and serving, in response, various item web pages. The application 206 can provide any type of website that supports user interaction, including social networking sites, online retailers, informational sites, blog sites, search engine sites, news and entertainment sites, and so forth. As discussed above, the described techniques can similarly be implemented outside of the application 206, such as with other applications running on the user devices 204.

The user devices 204 may be any type of computing device such as, but not limited to, a mobile phone, a smart phone, a personal digital assistant (PDA), a laptop computer, a desktop computer, a thin-client device, a tablet PC, an electronic book (e-book) reader, etc. In some examples, the user devices 204 may be in communication with the location computers 210 via the networks 208, or via other network connections. Additionally, the user devices 204 may be part of the distributed system managed by, controlled by, or otherwise part of the location computers 210 (e.g., a console device integrated with the location computers 210).

In one illustrative configuration, the user devices 204 may include at least one memory 214 and one or more processing units (or processor(s)) 216. The processor(s) 216 may be implemented as appropriate in hardware, computer-executable instructions, firmware, or combinations thereof. Computer-executable instruction or firmware implementations of the processor(s) 216 may include computer-executable or machine-executable instructions written in any suitable programming language to perform the various functions described. The user devices 204 may also include geo-location devices (e.g., a global positioning system (GPS) device or the like) for providing and/or recording geographic location information associated with the user devices 204.

The memory 214 may store program instructions that are loadable and executable on the processor(s) 216, as well as data generated during the execution of these programs. Depending on the configuration and type of user device 204, the memory 214 may be volatile (such as random access memory (RAM)) and/or non-volatile (such as read-only memory (ROM), flash memory, etc.). The user device 204 may also include additional removable storage and/or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 214 may include multiple different types of memory, such as static random access memory (SRAM), dynamic random access memory (DRAM), or ROM.

Turning to the contents of the memory 214 in more detail, the memory 214 may include an operating system and one or more application programs or services for implementing the features disclosed herein, such as via the browser application 206 or dedicated applications (e.g., smart phone applications, tablet applications, etc.). The browser application 206 may be configured to receive, store, and/or display a website or other interface for interacting with the location computers 210. Additionally, the memory 214 may store access credentials and/or other user information such as, but not limited to, user IDs, passwords, and/or other user information.

In some examples, the user information may include information for authenticating an account access request such as, but not limited to, a device ID, a cookie, an IP address, a location, or the like. In addition, the user information may include a user 202 provided response to a security question or a geographic location obtained by the user device 204.

In some aspects, the location computers 210 may also be any type of computing devices such as, but not limited to, a mobile phone, a smart phone, a personal digital assistant (PDA), a laptop computer, a desktop computer, a server computer, a thin-client device, a tablet PC, etc. Additionally, it should be noted that in some embodiments, the service provider computers are executed by one more virtual machines implemented in a hosted computing environment. The hosted computing environment may include one or more rapidly provisioned and released computing resources, which computing resources may include computing, networking and/or storage devices. A hosted computing environment may also be referred to as a cloud computing environment. In some examples, the location computers 210 may be in communication with the user devices 204 and/or other service providers via the networks 208, or via other network connections. The location computers 210 may include one or more servers, perhaps arranged in a cluster, as a server farm, or as individual servers not associated with one another. These servers may be configured to implement the content performance management described herein as part of an integrated, distributed computing environment.

In one illustrative configuration, the location computers 210 may include at least one memory 218 and one or more processing units (or processor(s)) 224. The processor(s) 224 may be implemented as appropriate in hardware, computer-executable instructions, firmware, or combinations thereof. Computer-executable instruction or firmware implementations of the processor(s) 224 may include computer-executable or machine-executable instructions written in any suitable programming language to perform the various functions described.

The memory 218 may store program instructions that are loadable and executable on the processor(s) 224, as well as data generated during the execution of these programs. Depending on the configuration and type of location computers 210, the memory 218 may be volatile (such as RAM) and/or non-volatile (such as ROM, flash memory, etc.). The location computers 210 or servers may also include additional storage 226, which may include removable storage and/or non-removable storage. The additional storage 226 may include, but is not limited to, magnetic storage, optical disks and/or tape storage. The disk drives and their associated computer-readable media may provide non-volatile storage of computer-readable instructions, data structures, program modules and other data for the computing devices. In some implementations, the memory 218 may include multiple different types of memory, such as SRAM, DRAM, or ROM.

The memory 218, the additional storage 226, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 218 and the additional storage 226 are all examples of computer storage media. Additional types of computer storage media that may be present in the location computers 210 may include, but are not limited to, PRAM, SRAM, DRAM, RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by the location computers 210. Combinations of any of the above should also be included within the scope of computer-readable media.

Alternatively, computer-readable communication media may include computer-readable instructions, program modules, or other data transmitted within a data signal, such as a carrier wave, or other transmission. However, as used herein, computer-readable storage media does not include computer-readable communication media.

The location computers 210 may also contain communications connection(s) 228 that allow the location computers 210 to communicate with a stored database, another computing device or server, user terminals and/or other devices on the networks 208. The location computers 210 may also include I/O device(s) 230, such as a keyboard, a mouse, a pen, a voice input device, a touch input device, a display, speakers, a printer, etc.

Turning to the contents of the memory 218 in more detail, the memory 218 may include an operating system 232, one or more data stores 234, and/or one or more application programs or services for implementing the features disclosed herein including a device module 236, a location module 238, a received audio module 240, a broadcast audio module 242, and/or an order history module 244. The modules may be software modules, hardware modules, or a combination thereof. If the modules are software modules, the modules will be embodied on a computer readable medium and processed by a processor in any of computer systems described herein.

The device module 236 may be configured to determine one or more identifiers associated with devices or computers. For example, the location computers 210 may receive the identifier from a second computer (e.g., the second computer may “push” the identifier, etc.) or the location computers 210 may query the computer for its identifier and the second computer may respond with its identifier by transmitting a communication with the identifier in the message to the location computers 210.

The location module 238 may be configured to determine a location of one or more devices, including cellular base stations 250 and user devices 204. The determination may be based at least in part on receiving latitude longitude coordinates of the device from a positioning system (e.g., GPS, etc.), or based at least in part on the audio analysis, cellular base station identifier analysis, or other location determination processes discussed herein.

The received audio module 240 may be configured to analyze audio components and features of the audio that is received from the microphone of the user device 204, microphone of the resource provider building 110, or other audio sources.

The broadcast audio module 242 may be configured to provide audio. For example, the provided audio may comprise audio that is broadcast via a particular frequency spectrum to one or more locations. The broadcast audio may be generic for the variety of location that receive the broadcast, or comprise a unique audio component for a particular location that receives the broadcast.

The order history module 244 may be configured to determine an order history associated with the user operating the user device 204. The order history may comprise items from a resource provider, order dates, shipping locations, and other relevant information.

The user devices 204 may communicate through one or more networks accessible by one or more base stations 250. The one or more base stations 250 may comprise a cellular base station accessible via a telecommunications protocol (e.g., femtocell or picocell base station, etc.). The one or more base stations 250 may comprise macrocells, microcells, or picocells, for example, and may be accessible by one or more user device 204. The one or more base stations 250 may relay information to and from the user devices 204, as well as relay information to and from a mobile or wireless service provider in accordance with the telecommunications or internet protocol.

The cellular base station may be operable to establish communication connections in accordance with a plurality of telecommunications protocols. In some examples, the cellular base station may be located within a building that is associated with a same entity as the information server.

The cellular base station may be a static or dynamic communications location that is part of a network's wireless telephone system. For example, the cellular base station may be fixed to a particular, immoveable location and the user devices 204 may connect to a wider communication network after communicating with this cellular base station.

FIG. 3 illustrates an illustrative flow for revising audio for broadcast described herein, according to at least one example. The process 300 may begin with broadcasting audio at 302. For example, the computer system 304 may broadcast audio 306 via one or more communication mediums. The audio 306 may comprise spatial and/or temporal frequency data. The computing device 304 may be similar to location computers 210 illustrated in FIG. 2.

The broadcasting may be transmitted via various broadcasting mediums known in the art, including radio or digital broadcasting, or via analog or digital transmissions. For example, the computer system 304 may broadcast the audio 306 through a unidirectional wireless transmission over radio waves and one or more radio antennas can receive the radio waves. The audio broadcasting may be configured to provide cable radio, television networks, satellite radio, or internet radio via streaming media on the communication medium (e.g., Internet, etc.).

Broadcasting may transmit various types of modulation (e.g., amplitude modulation or frequency modulation in radio broadcasting, orthogonal frequency division multiplexing

(OFDM) and phase-shift keying (PSK) modulation for digital broadcasting, etc.) and one or more antennas may accept the audio from the transmitting antenna associated with computer system 304. The receiving antenna may be communicatively coupled with a receiver. The receiver may implement tuning (e.g., removes data other than the broadcast audio, etc.) and decoding. The receiver may comprise an oscillator and/or an audio amplifier that can be transmitted through one or more speakers (e.g., transducers, etc.) associated with a second computer 322.

The process 300 may comprise revising the audio at 320. For example, a second computer 322 can receive the broadcast audio 306 based on the signal generated by the computer system 304. The second computer 322 may provide the broadcast audio 306 through one or more speakers in a building 334 or other space associated with the second computer 322.

The second computer 322 can also access a unique audio component from a data store 324 associated with the second computer 322. This data store 322 may comprise an electronic data store (e.g., associated with the computer 322, etc.), a portable storage drive, and the like. In some examples, the data store 322 may comprise streaming media and not permanently store data at all. In some examples, the audio may be stored in a memory that is not also associated with a computer (e.g., universal serial bus (USB), a record player, etc.). The second computer 322 may revise the audio by combining the broadcast audio 306 with the unique audio component from the data store 324.

The process 300 may broadcast the revised audio at 330. For example, the second computer 322 can combine the broadcast audio 306 with the unique audio component from the data store 324 to form second audio 332 emitted through one or more speakers in a building 334 or other space associated with the second computer 322.

In some examples, a different unique audio component may be associated and identified with each different sublocation within building 334, such that different sublocations in the same building correspond to different audio signals. When transmitted to the second computer 322, the second computer 322 may receive the first and second data based on different signals generated by the same microphone associated with the user device at two different intervals of time. The second computer 322 may identify a second audio component based on the received second data and determine a second location of the mobile device based at least in part on the identified audio component. This process may be similar to the analysis of the first data received by the second computer 322, but the second computer 322 may determine that the second data corresponds with a second location. In some examples, the second data is within a same building as the first location but in a different sublocation. The second computer 322 may provide the second location of the user device to the user device or other computer.

FIG. 4 illustrates an illustrative flow for associating audio with a location described herein, according to at least one example. The process 400 may begin with receiving audio at 402. For example, a microphone 404 may receive audio from various sources and transmit the audio to a computer system 406 via one or more communication mediums. The computing device 406 may be similar to location computers 210 illustrated in FIG. 2.

The audio sources may include environmental audio within a proximate distance to the microphone 404. This may include conversations, automobile noise, bell ringing, or buzzing. For example, the conversations may be conducted adjacent to the microphone, so that the microphone may record audio corresponding with the individuals' voices. The automobile noise may correspond with standard traffic audio from a street or roadway. When the microphone 404 is adjacent to the road, the automobile noise (e.g., sirens, honking, exhaust sounds, etc.) may be captured by the microphone 404.

The microphone 404 may be at a known location. For example, the microphone 404 may be affixed to a location in a building that is immovable or static for a duration of time. In another example, the microphone 404 may be associated with a positioning system (GPS) that can identify geophysical coordinates (e.g., the latitude-longitude coordinates) of the microphone 404 (e.g., a computing device that incorporates the position system, etc.). The position of the microphone 404 may be dynamic, but known, in some examples.

In some examples, the computing device 406 may filter the audio. For example, after receiving the second data, the computing device 406 may filter the second data to remove noise from the second data. This filtered second data may then be compared with the first data. In some examples, the filter may be implemented when the source of the data is a lower quality microphone that is unable to filter at the time when the audio is recorded from the source (e.g., a microphone incorporated with a user device, etc.).

The process 400 may associate the audio with a location at 430. For example, the microphone 404 may transmit the audio to the computing device 406, which stores the audio at a data store 432. The audio may be associated with the location, for example, by associating the location of the microphone 404, identified by the static or dynamic positioning of the microphone 404, with the audio received by the microphone 404. As illustrated in data store 432, a first location may correspond with a first audio segment and a second location may correspond with a second audio segment. Each of these audio segments may correspond with different location data (e.g., latitude-longitude coordinates, absolute value position, etc.).

FIG. 5 illustrates an illustrative flow for correlating data described herein, according to at least one example. In some examples, embodiments of the disclosure may limit the number of audio sources that the computer system receives and analyzes. For example, various user devices may be enabled to activate a microphone included with the user device, but only some of the user devices within a plurality of user devices may also record and/or transmit the audio from the device to the computer system. The microphone at the user device may be activated and receive the broadcast music and/or unique audio signal transmitted by the speakers when the user device is selected from the plurality of user devices.

The device may be selected based on the device's home location or shipping location.

For example, a location of a mobile device may be identified based at least in part on correlating data between a user that operates the mobile device and a location. When the mobile device and/or user has in the past or will plan to interact in the future with the location, the location of the mobile device may be identified using one or more examples discussed herein. In some examples, the location of the mobile device may be identified when a home location associated with the mobile device and/or user is within a particular distance of a general shipping location. The user may be offered the ability to accept a shipped item at the general shipping location when a location identified by the user (e.g., work, home, preferred location in a user profile, etc.) is within a particular distance of the general shipping location (e.g., to receive the item quicker, etc.).

The process 500 can begin with identifying one or more zip codes at 502. The zip codes may be identified around a location 504. For example, a computer system 512 may identify one or more zip codes 506 (illustrated as zip code A 506A, zip code B 506B, and zip code C 506C) around location 504 within a particular distance (e.g., within one mile, within ten minutes commuting to the location from a second location within the zip code, etc.).

The process 500 may comprise correlating order history with zip codes at 510. For example, the computer system 512 can access a data store 514 that comprise a profile 516 of the user associated with the mobile device. The profile 516 may comprise a user identifier, device identifier, one or more items associated with the user (e.g., ordered, returned, etc.), and a location where those items were requested to be shipped (e.g., zip code C, zip code G, etc.). The device identifier may comprise a variety of information, including a telephone number, nickname, International Mobile Equipment Identity (IMEI), Mobile Equipment Identifier (MEID), Electronic Serial Number (ESN), International Mobile Subscriber Identity (IMSI), or other identifiers of a mobile device.

The process 500 may comprise determining an audio correlation at 520. For example, the computer system 512 may identify the device identifier associated with a message that the computer system 512 receives via a network. The message may comprise audio or other data that originated from the mobile device. The computer system 512 can identify the originator of the message by decoding the message to identify the device identifier, comparing the device identifier with stored identifiers in data store 514, and matching the received identifier with a stored identifier. In some examples, the correlation may be conducted to correlate the base station identifier with shared data as well, at least in part to identify the origin of the message as the user device, and also to identify a communication channel associated with the base station identifier from the same message.

Once the origin of the message is identified as corresponding with a particular device identifier, the computer system 512 can analyze the data in the message. For example, when an audio recording is included with the message, the audio recording may be associated with the identified mobile device 522. As illustrated herein, when the audio comprises an audio component that is unique to a known location (e.g., an inaudible sound that is broadcast with a generic audio component, etc.), the computer system 512 can determine that the mobile device 522 may also be in that known location, based at least in part on the unique audio component. In another example, when the audio from the identified mobile device 522 comprises an audio component that is received from a second microphone with a known location (e.g., conversations, road noise, etc.), the computer system 512 can determine that the mobile device 522 may also be in that known location, based at least in part on the audio component received from the second microphone.

In some examples, data from at least a subset of the plurality of user device may not be received (e.g., after the zip codes and locations are analyzed as provided herein, etc.). As a sample illustration, the computer system may determine a second location associated with a user operating a second mobile device (e.g., a shipping address, a home address, a preferred address identified in a user profile, etc.) and a third location associated with a point of interest location (e.g., the resource provider building 110, etc.). When the second location is greater than a proximate distance of the third location (e.g., more than a mile, more than ten minutes commuting from the second location to the third location based on travel time, etc.), the computer system may prevent a receipt of audio data from the second mobile device, based at least in part on the proximate distance.

FIG. 6 illustrates an illustrative flow for determining location data associated with one or more cellular base stations described herein, according to at least one example. For example, rather than audio, the data received by the computer system may comprise data associated with one or more cellular base stations, at least in part to determine a location of a mobile device 604 (e.g., a mobile telephone). The mobile device 604 and information server may implement various processes described herein, including various processes based on one or more operating systems associated with the mobile telephone.

The process 600 may begin by establishing a first connection at 602. For example, the first connection may be established by the mobile device 604 with a cellular base station 606 in accordance with a telecommunications protocol. The telecommunications protocol may comprise one or more telecommunications protocols known in the art, including 3G, LTE (Long Term Evolution), and the like. Particular technologies may be used with each telecommunications protocol as well, including Global System for Mobiles (GSM) and Code Division Multiple Access (CDMA) through various service providers (e.g., AT&T® and T-Mobile® use the GSM technology, Verizon® and Sprint® use the CDMA technology, etc.). In some examples, the telecommunications protocol may not include Wi-Fi or triangulation of one or more cellular base stations.

The mobile device 604 may establish a second connection at 620 with a computer system 624 that may be associated with one or more antennas and/or base stations. The mobile device 604 may communicate with the computer system 624 via an application module installed and/or registered with the mobile device 604.

In some examples, the application module may be actively registered. For example, the application module may be accessed by a user operating the mobile device 604 through a browser application, where the application module is stored with the computer system 624. The user operating the mobile device 604 may provide a network address to the browser application to access the application module, and then provide a username and password to access profile-specific data that is remote from the mobile device 604. After authenticating the username and password, the computer system 624 may, in some examples, transmit an authentication code to the application module to verify authentication and access of the mobile device 604 to the application module. In some examples, the application module may be stored locally at the mobile device 604 and the access to profile-specific data is local to the mobile device via the application module. In yet another example, when the user activates the application module, the application module may connect with the computer system 624, according to an internet protocol. The computer system 624 may receive the username and password of the user and provide additional access or data to the user, accessible through the application stored at the mobile device 604.

In some examples of the registration process of the application module, the registration may be passive. For example, the application module may be installed at the mobile device 604.

The application module may initiate a handshake or other communication with the computer system 624, either after a user's interaction with the application module or according to a predetermined time. This handshake process may comprise transmitting a mobile device identifier (e.g., a telephone number, nickname, International Mobile Equipment Identity (IMEI), Mobile Equipment Identifier (MEID), Electronic Serial Number (ESN), International Mobile

Subscriber Identity (IMSI), or other identifiers of a mobile device, etc.) to the computer system 624. The computer system 624 may compare the device identifier with a stored identifier associated with one or more user profiles (e.g., to identify additional information about the user and/or mobile device 604, etc.). After authenticating the device identifier, the computer system 624 may, in some examples, transmit an authentication code to the application module to verify authentication and access of the mobile device 604 to the application module.

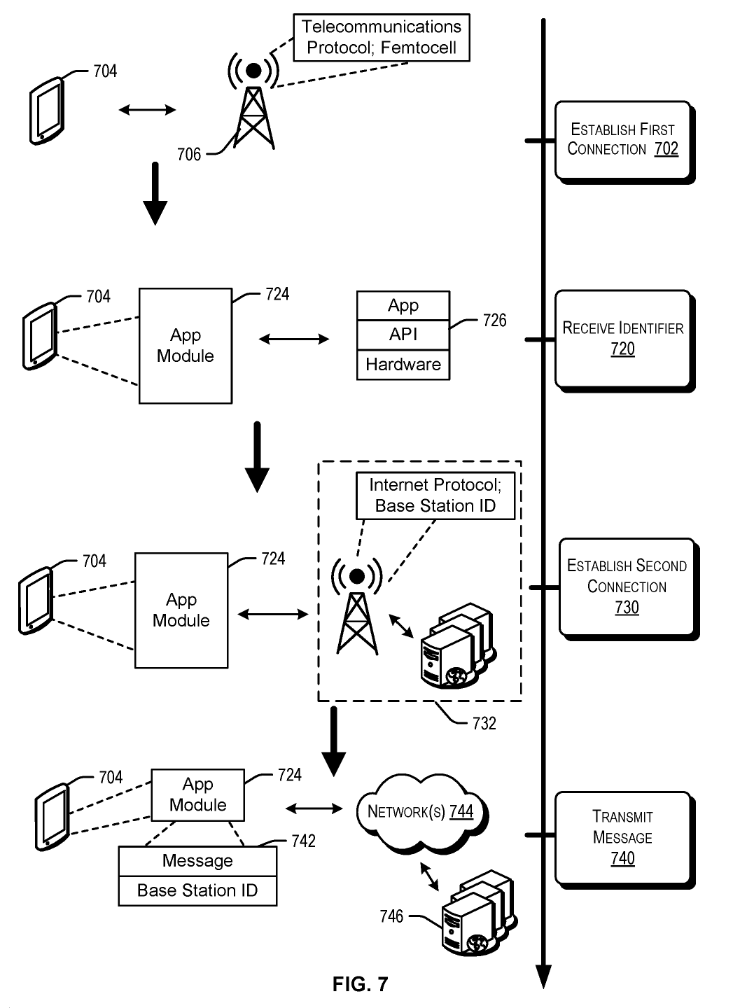

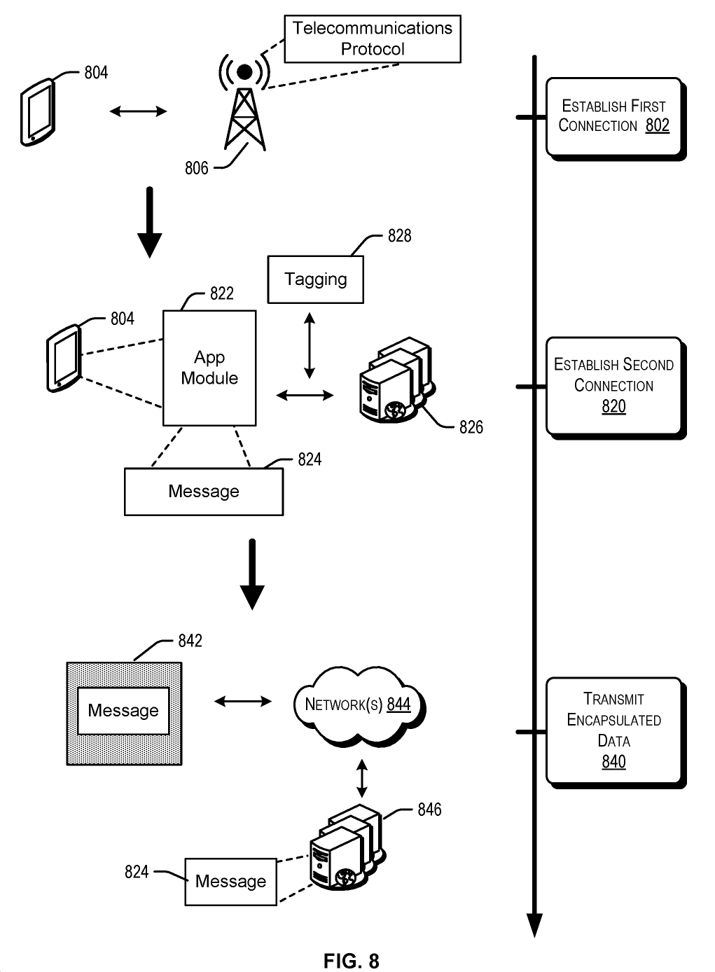

The communications associated with this second connection may vary, based at least in part on the operating system or other specifications of the mobile device 604, as illustrated in FIG. 7 and FIG. 8. For example, the second connection between the application module and the computer system 624 may be a communication connection maintained with an internet protocol.

FIG. 7 illustrates an illustrative flow for determining location data based on one type of operating system installed at the mobile device (e.g., an Android® operating system, etc.). For example, at 702, the mobile device 704 may establish a communication connection to a cellular base station 706 in accordance with a telecommunication protocol, as discussed with FIG. 6.

In some examples, the base stations may be ranked. For example, the communication connection to the cellular base station 706 may be a first initial communication. The mobile device 704 may identify a second cellular base station in accordance with the same telecommunications protocol. The mobile device 704 may rank a relative signal strength corresponding with the first cellular base station and the second cellular base station and establish the first communication to the first cellular base station based on the ranking (e.g., the strongest signal, the closest base station, etc.).

At 720, the mobile device 704 may receive an identifier of the cellular base station 706 (e.g., through a handshake or ping of the cellular base station, etc.). The cellular base station identifier may be stored with a hardware layer of the open systems interconnection (OSI) model, whereas the application layer of the OSI model may need the information. An application programming interface (API) implemented by the operating system of the mobile device 704 may provide access to the identifier from the hardware layer from the application layer.

At 730, the mobile device 704 may establish a second connection. For example, the mobile device 704 may communicate with the computer system 732 via an application module 724 installed and/or registered with the mobile device 704. The application module 724 may establish an internet protocol (IP) based communication connection with a corresponding server module hosted by the computer system 732. For example, the application module 724 may be configured to present localized information to the user with the mobile device, and the server may be configured to provide the localized information to the mobile device for presentation.

At 740, the mobile device 704 may send a message with the identifier to the computing system (e.g., location information server, etc.) in accordance with the second connection (e.g., the internet protocol, etc.). For example, the application module 724 may generate a message 742 and include the base station identifier with the message. The application module 724 may transmit the message in accordance with an internet protocol over the established second connection to the computer system 746 via the communication network 744.

In some examples, the location of the cellular base station may comprise geophysical coordinates (e.g., the latitude-longitude coordinates) of the cellular base station stored with a location information server or computer system 746.

FIG. 8 illustrates an illustrative flow for determining location data based on one type of operating system installed at the mobile device (e.g., an iOS® operating system, etc.). For example, at 802, the mobile device 804 may establish a communication connection to a cellular base station 806 in accordance with a telecommunication protocol as discussed with FIG. 6.

At 820, the mobile device 804 may communicate with a computing system 826 using an application module 822. In some examples, the application module 822 may be registered with a computer system 826 and stored with the mobile device 804. The application module 822 may enable the second communication connection to the location information server via the application module 822. The application module 822 may transmit a message 824 to the computing system 826 via the established connection.

In some examples, the cellular base station may tag 828 the message prior to the computer system 826 receiving the message with an identifier of the cellular base station (e.g., by extending the internet protocol or a higher layer protocol). In some examples, the message 824 may be received by the cellular base station and modify the message 824, which may include the tagging process to form encapsulated data. The encapsulated data may comprise a header that is also in accordance with the internet protocol and associated with the cellular base station 806.

In some examples, the identifier of the cellular base station 806 may be included in the header of the internet protocol message. For example, the computer system 826 can receive the message via the second communication connection and parse the to determine the identifier of the cellular base station 806 in a header of the message.

At 840, the mobile device 804 may transmit encapsulated data to the computing system 846 via the network 844. The computer system 846 may undo the modification to the message 824 by parsing and/or decoding the received encapsulated data to obtain the original message 824. In some examples, the mobile device 804 may transmit the message to a gateway computer. The gateway computer may be enabled to add a header to the message that indicates the identifier of the cellular base station.

Returning to FIG. 6, the computing system 642 (e.g., location information server, computer system 104, etc.) may send a response to the mobile device 604 and/or the application maintained by mobile device 604 at 640. For example, the computing system 642 may transmit a message corresponding with the identified location of the mobile device (e.g., with respect to the base station identifier, etc.) to the mobile device 604. The mobile device 604 may then receive a location of the cellular base station from the computing system 642 based at least in part on the identifier of the cellar base station.

In some examples, the mobile device 604 may display additional information via a display incorporated with the mobile device 604. The additional information may be localized based at least in part on the identified location. In accordance with at least some embodiments, the additional information may include offers or advertisements associated with the identified location of the mobile device 604 (e.g., close to or within a proximity distance of the location of the cellular base station 606, etc.).

The additional information provided by the mobile device 604 may include localized information based at least in part on the location received from a location information server. In some examples, the location (e.g., the resource provider building 110, etc.) corresponds to an item distribution location having an inventory of items and the localized information is based at least in part on the inventory of items at the item distribution location.

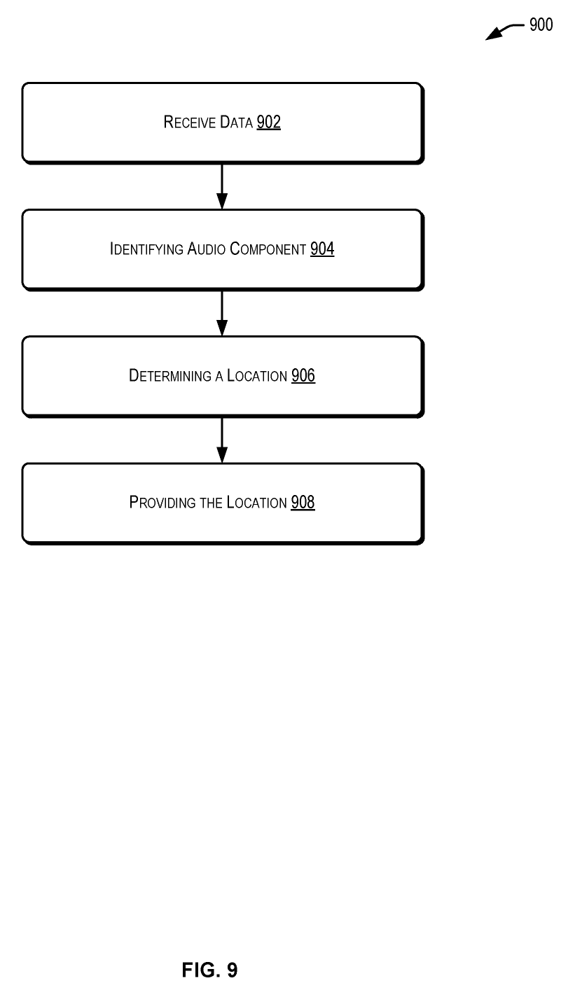

FIG. 9 illustrates an example flow diagram for determining location data based on audio described herein, according to at least one example. In some examples, the one or more location computers 210 (e.g., utilizing at least one of the device module 236, location module 238, received audio module 240, broadcast audio module 242, and/or order history module 244) or one or more user devices 204 shown in FIG. 2 may perform the process 900 of FIG. 9.

Some or all of the process 900 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 900 may begin at 902 by receiving data by a computer system. For example, the location computers 210 may receive data based on a signal generated by a microphone of a mobile device that corresponds to audio generated by a speaker at a location during an interval of time, the audio broadcast at the location comprising a first audio component that is unique to the location and a second audio component that is generic to a plurality of locations. The data may include an audio stream and the audio may be sound waves.

At 904, the location computers 210 may extract, compare, and/or identify data. For example, in one embodiment, the location computers 210 may extract a first audio component that is unique to the location from the received data and comparing a first representation of the first audio component with a second representation of stored audio components. The comparison may be conducted with one or more representations of the audio (e.g., audio fingerprints, etc.). In some examples, the stored audio components may correspond with known locations. In another embodiment, the location computers 210 may identify the audio component based on a different process (e.g., signal analysis, etc.).

At 906, a location may be determined. For example, the location computers 210 may determine a location of the mobile device based at least in part on the comparison between the first representation of the first audio component and the second representation of the stored audio components. The location of the mobile device may be determined based at least in part on the identified audio component that is unique to the location. For example, a database of unique audio signals being played at each location and/or sublocation may be maintained, and a match (e.g., a comparison indicating a small and/or minimal difference, such as a difference less than a threshold) may be mapped to the corresponding location.

At 908, a location may be provided. For example, the location computers 210 may provide the location of the mobile device to the mobile device.

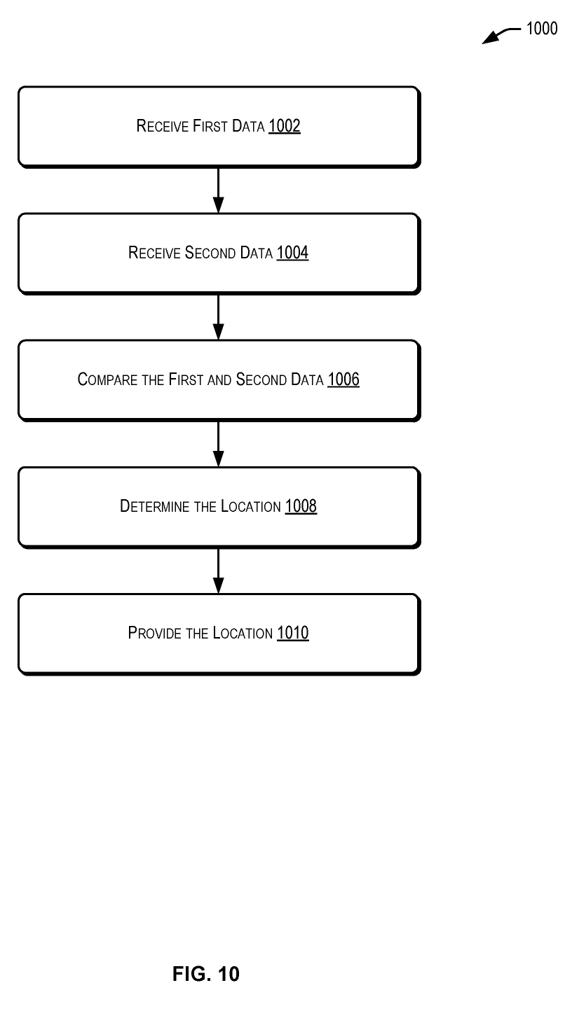

FIG. 10 illustrates an example flow diagram for determining location data based on audio described herein, according to at least one example. In some examples, the one or more location computers 210 (e.g., utilizing at least one of the device module 236, location module 238, received audio module 240, broadcast audio module 242, and/or order history module 244) or one or more user devices 204 shown in FIG. 2 may perform the process 1000 of FIG. 10.

Some or all of the process 1000 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1000 may begin at 1002 by receiving first data by the computer system. For example, the location computers 210 may receive first data based on a first signal generated by a first microphone at a known location during an interval of time. In some examples, the known location may be static or dynamic during the interval of time.

At 1004, second data may be received. For example, the location computers 210 may receive second data based on a second signal generated by a second microphone of a mobile device during the interval of time.

At 1006, the first and second data may be compared. For example, the location computers 210 may compare the first data associated with the first signal generated by the first microphone with the second data associated with the second signal generated by the second microphone. In some examples, the comparison may comprise subtracting the first data and the second data to determine a difference (e.g., in the time domain and/or the frequency domain). There may be multiple location candidates, each with a microphone (e.g., a fixed or static microphone) streaming different environmental audio to the location computers 210. The second data from the microphone of the mobile device may be compared to corresponding data from each of the location candidates to determine a match. The second data may match data from each candidate with different levels of confidence.

At 1008, a location may be determined. For example, the location computers 210 may determine that the mobile device is at the known location based on the comparing. In some examples, the determination may be conducted when the difference between the first data and the second data is below a difference threshold or set of difference thresholds (e.g., corresponding to different portions of the audio spectrum). Where there are multiple candidates providing first data, the candidate having a highest confidence match with the second data may be selected as the determined location.

At 1010, a location may be provided. For example, the location computers 210 may provide the location of the mobile device to the mobile device.

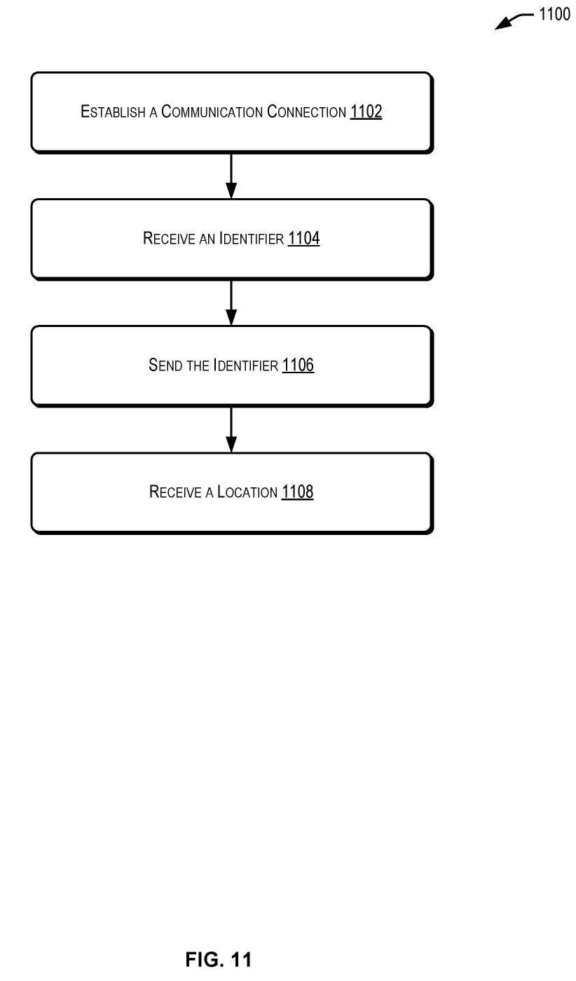

FIG. 11 illustrates an example flow diagram for determining location data based on audio described herein, according to at least one example. In some examples, the one or more location computers 210 (e.g., utilizing at least one of the device module 236, location module 238, received audio module 240, broadcast audio module 242, and/or order history module 244) or one or more user devices 204 shown in FIG. 2 may perform the process 1100 of FIG. 11.

Some or all of the process 1100 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1100 may begin at 1102 by establishing a communication connection. For example, the user device 204 (e.g., mobile device, mobile telephone, etc.) can establish a communication connection to a cellular base station in accordance with a telecommunication protocol. The user device 204 may be a mobile telephone that uses a telecommunication protocol and the cellular base station may be a femtocell, microcell, or picocell. The communication connection can correspond with an initial handshake to register the user device 204 with the cellular base station.

At 1104, an identifier may be received. For example, the user device 204 may receive the identifier of the cellular base station. The identifier may be received with an application programming interface (API) of the user device 204. The API may be implemented between the application module of the user device 204 and the cellphone hardware. In some examples, the API may only be available on some operating systems (e.g., on Android®, not iOS®, etc.).

At 1106, the identifier may be sent. For example, the user device 204 may send the identifier of the cellular base station to a location information server in accordance with an internet protocol.

At 1108, a location may be received. For example, the user device 204 may receive a location of the cellular base station from the location information server based at least in part on the identifier of the cellar base station.

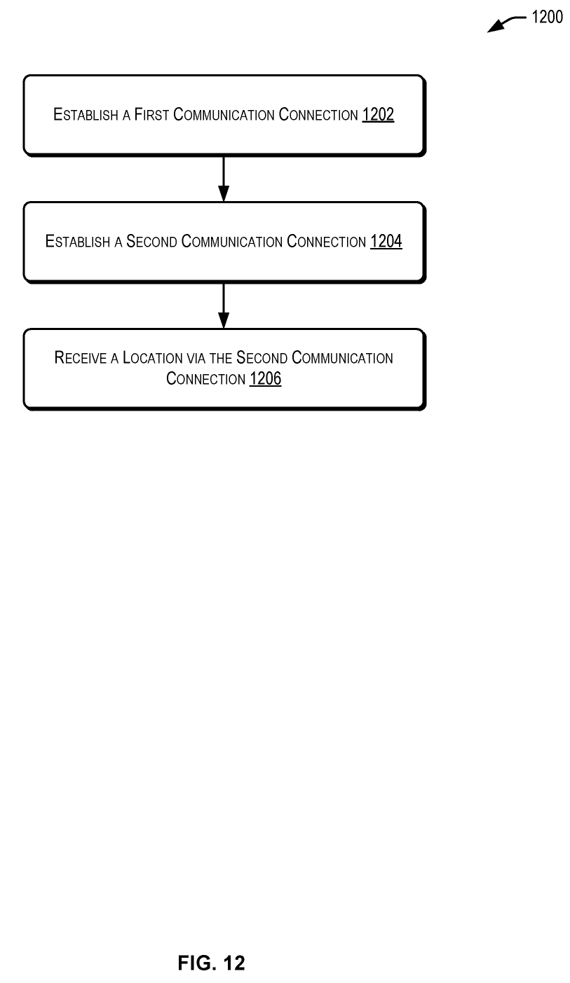

FIG. 12 illustrates an example flow diagram for determining location data based on audio described herein, according to at least one example. In some examples, the one or more location computers 210 (e.g., utilizing at least one of the device module 236, location module 238, received audio module 240, broadcast audio module 242, and/or order history module 244) or one or more user devices 204 shown in FIG. 2 may perform the process 1200 of FIG. 12.

Some or all of the process 1200 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1200 may begin at 1202 by establishing a first connection. For example, the user device 204 (e.g., mobile device, mobile telephone, etc.) may establish a first communication connection to a cellular base station in accordance with a telecommunication protocol.

At 1204, a second communication connection may be established. For example, the user device 204 may establish a second communication connection to a location information server in accordance with an internet protocol. The second communication connection may be implemented at least in part with the first communication connection (e.g., the first and second communication connections may be associated with different protocols and/or layers of the OSI protocol stack). In some examples, the cellular base station may cause a message sent over the second communication connection to indicate an identifier of the cellular base station (e.g., the base station may tag or modify a message sent over the second communication connection to include an identifier of the base station).

At 1206, a location may be received. For example, the user device 204 may receive, over the second communication connection, a location of the cellular base station from the location information server. The location may be based at least in part on the identifier of the cellar base station.

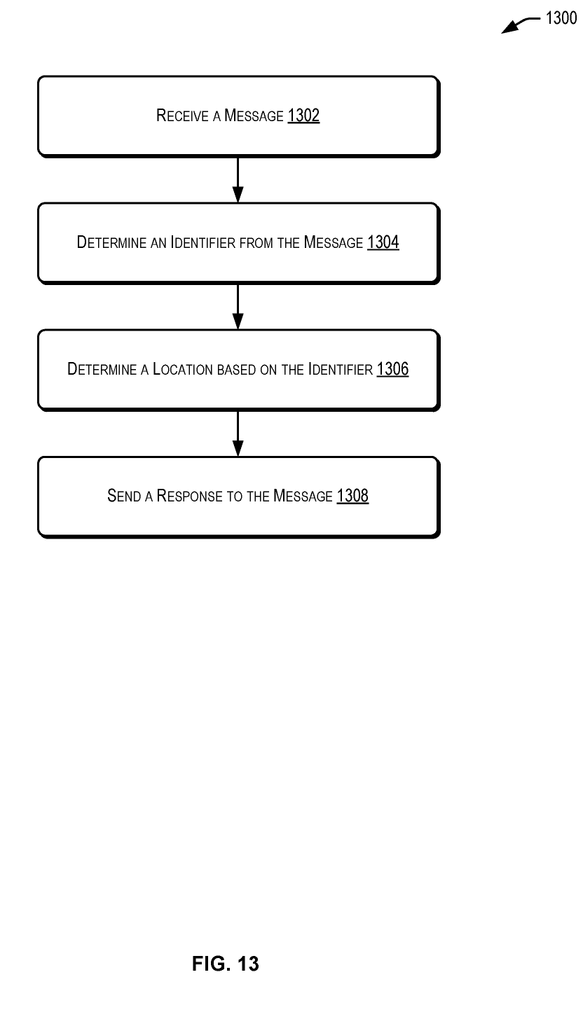

FIG. 13 illustrates an example flow diagram for determining location data based on audio described herein, according to at least one example. In some examples, the one or more location computers 210 (e.g., utilizing at least one of the device module 236, location module 238, received audio module 240, broadcast audio module 242, and/or order history module 244) or one or more user devices 204 shown in FIG. 2 may perform the process 1300 of FIG. 13.

Some or all of the process 1300 (or any other processes described herein, or variations, and/or combinations thereof) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1300 may begin at 1302 by receiving a message. For example, the location computer 210 (or “information server,” used interchangeably) may receive a message from an application module on a mobile telephone in accordance with an internet protocol. The message may be sent over a communication connection established by the mobile telephone through a cellular base station. The message may have been modified by the cellular base station to indicate an identifier of the cellular base station.

In some examples, the message may be explicitly modified by the cellular base station (thereby transgressing protocol encapsulation). In some examples, the process may include tagging or wrapping the message with additional information by the cellular base station and/or a computer associated with the cellular base station.

At 1304, an identifier may be determined from the message. For example, the location computer 210 may determine the identifier of the cellular base station based at least in part on the modified message.

At 1306, a location may be determined based on the identifier. For example, the location computer 210 may determine a location of the cellular base station based at least in part on the identifier.

At 1308, a response to the message may be sent. For example, the location computer 210 may send a response to the message having content based at least in part on the determined location. The response may be transmitted to the application module of the user device.

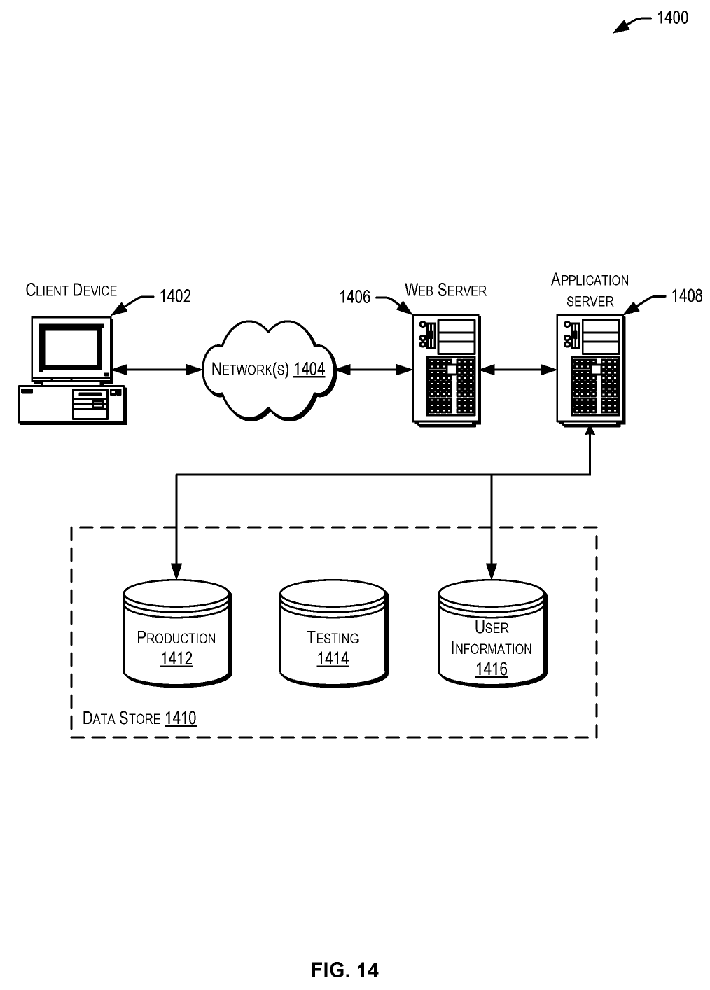

FIG. 14 illustrates aspects of an example environment 1400 for implementing aspects in accordance with various embodiments. As will be appreciated, although a Web-based environment is used for purposes of explanation, different environments may be used, as appropriate, to implement various embodiments. The environment includes an electronic client device 1402, which can include any appropriate device operable to send and receive requests, messages, or information over an appropriate network 1404 and convey information back to a user of the device. Examples of such client devices include personal computers, cell phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections and combinations thereof. In this example, the network includes the Internet, as the environment includes a Web server 1406 for receiving requests and serving content in response thereto, although for other networks an alternative device serving a similar purpose could be used as would be apparent to one of ordinary skill in the art.

The illustrative environment includes at least one application server 1408 and a data store 1410. It should be understood that there can be several application servers, layers, or other elements, processes, or components, which may be chained or otherwise configured, which can interact to perform tasks such as obtaining data from an appropriate data store. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store and is able to generate content such as text, graphics, audio, and/or video to be transferred to the user, which may be served to the user by the Web server in the form of HyperText Markup Language (“HTML”), Extensible Markup Language (“XML”), or another appropriate structured language in this example. The handling of all requests and responses, as well as the delivery of content between the client device 1402 and the application server 1408, can be handled by the Web server. It should be understood that the Web and application servers are not required and are merely example components, as structured code discussed herein can be executed on any appropriate device or host machine as discussed elsewhere herein.

The data store 1410 can include several separate data tables, databases or other data storage mechanisms and media for storing data relating to a particular aspect. For example, the data store illustrated includes mechanisms for storing production data 1412 and user information 1416, which can be used to serve content for the production side. The data store also is shown to include a mechanism for storing log data 1414, which can be used for reporting, analysis, or other such purposes. It should be understood that there can be many other aspects that may need to be stored in the data store, such as for page image information and to access right information, which can be stored in any of the above listed mechanisms as appropriate or in additional mechanisms in the data store 1410. The data store 1410 is operable, through logic associated therewith, to receive instructions from the application server 1408 and obtain, update or otherwise process data in response thereto. In one example, a user might submit a search request for a certain type of item. In this case, the data store might access the user information to verify the identity of the user and can access the catalog detail information to obtain information about items of that type. The information then can be returned to the user, such as in a results listing on a Web page that the user is able to view via a browser on the user device 1402. Information for a particular item of interest can be viewed in a dedicated page or window of the browser.

Each server typically will include an operating system that provides executable program instructions for the general administration and operation of that server and typically will include a computer-readable storage medium (e.g., a hard disk, random access memory, read only memory, etc.) storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 14. Thus, the depiction of the system 1400 in FIG. 14 should be taken as being illustrative in nature and not limiting to the scope of the disclosure.

The various embodiments further can be implemented in a wide variety of operating environments, which in some cases can include one or more user computers, computing devices or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof

In embodiments utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C#, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

1. A computer-implemented method, comprising:
receiving, by a computer system, first data based on a first signal generated by a first microphone at a known location during an interval of time;
updating, by the computer system, an audio map that establishes a correlation between the first signal and the known location, the audio map comprising a plurality of audio signals that correlate to a plurality of geographical locations;
receiving, by the computer system, second data based on a second signal generated by a second microphone of a mobile device during the interval of time;
comparing at least one of the plurality of audio signals of the audio map with the second signal, the comparison comprising subtracting the first data and the second data to determine a difference between the first data associated with the first signal and the second data associated with the second signal;
when the difference between the first data and the second data is below a difference threshold, determining, by the computer system, that the mobile device is at the known location of the audio map based at least in part on the comparing; and
providing, by the computer system, the known location of the mobile device to the mobile device.

2. The computer-implemented method of claim 1, further comprising:
after receiving the second data, filtering the second data to remove noise from the second data, wherein the filtered second data is compared with the first data.

3. The computer-implemented method of claim 1, wherein the first data comprises conversations, automobile noise, bell ringing, or buzzing.

4. The computer-implemented method of claim 1, wherein the first microphone is a fixed microphone at the known location.

5. The computer-implemented method of claim 1, wherein the first microphone is a dynamic microphone that moves to the known location during the interval of time.

6. A computer-implemented method, comprising:
receiving, by a computer system, first data based on a first signal generated by a first microphone at a known location during an interval of time, the known location of the first microphone being static during the interval of time;
updating, by the computer system, an audio map that establishes a correlation between the first signal and the known location, the audio map comprising a plurality of audio signals that correlate to a plurality of geographical locations;
receiving, by the computer system, second data based on a second signal generated by a second microphone of a mobile device during the interval of time;
comparing at least one of the plurality of audio signals of the audio map with the second signal;
determining, by the computer system, that the mobile device is at the known location of the audio map based at least in part on the comparing; and
providing, by the computer system, the known location of the mobile device to the mobile device.

7. The computer-implemented method of claim 6, wherein the comparing comprises subtracting the first data and the second data to determine a difference, and the method further comprises:
incorporating the determination of the difference between the first data and the second data with the determination that the mobile device is at the location.

8. The computer-implemented method of claim 6, wherein determining that the mobile device is at the location further comprises:
applying a Fourier transform to the first data and the second data;
determining coefficients for each the first data and the second data;
when the coefficients are within a coefficient threshold, determining that the second signal generated by the second microphone is similar to the first signal generated by the first microphone.

9. The computer-implemented method of claim 6, wherein the first data associated with the first signal generated by the first microphone comprises an audio component that is unique to the known location.

10. The computer-implemented method of claim 6, wherein the first data at the known location comprises a plurality of audio components unique to the known location and the known location comprises a plurality of sublocations each corresponding to one of the plurality of audio components unique to the known location.

11. The computer-implemented method of claim 6, further comprising:
providing additional information to the mobile device, based at least in part on the known location of the mobile device.

12. One or more computer-readable non-transitory storage media collectively storing computer-executable instructions that, when executed by one or more computer systems, configure the one or more computer systems to collectively perform operations comprising:
receiving first data based on a first signal generated by a first microphone at a known location during an interval of time, the known location of the first microphone being dynamic during the interval of time;
updating an audio map that establishes a correlation between the first signal and the known location, the audio map comprising a plurality of audio signals that correlate to a plurality of geographical locations;
receiving second data based on a second signal generated by a second microphone of a mobile device during the interval of time;
comparing at least one of the plurality of audio signals of the audio map with the second signal;
determining that the mobile device is at the known location of the audio map based at least in part on the comparing; and
providing the known location of the mobile device to the mobile device.

13. The one or more computer systems of claim 12, wherein the known location comprises latitude-longitude coordinates received from a positioning system associated with the known location.

14. The one or more computer systems of claim 12, wherein the first data and the second data are live audio streams.

15. The one or more computer systems of claim 12, wherein the known location is a first location, and wherein the operations further comprise:
receiving second data based on a second signal generated by the microphone of the mobile device during a second interval of time;
identifying a second audio component based on the received second data;
determining a second location of the mobile device based at least in part on the identified audio component, wherein the second location is within a same building as the first location but in a different sublocation; and
providing the second location of the mobile device to the mobile device.

16. The one or more computer systems of claim 12, wherein the operations further comprise:
determining a value of the second data;
comparing the value of the second data with a confidence threshold; and
generating a confidence score based at least in part on the comparison of the value of the second data and the confidence threshold.

17. The one or more computer systems of claim 12, wherein the mobile device does not transmit the location of the mobile device using location services.

18. The one or more computer systems of claim 12, wherein the microphone records and transmits at least four seconds of the audio generated by the speaker.

19. The one or more computer systems of claim 12, wherein the microphone starts recording after an application module is accessed at the mobile device for a different purpose than recording audio generated by the speaker at the known location.

20. The one or more computer systems of claim 12, wherein the operations further comprise:
determining a second location associated with a user operating a second mobile device;
determining a third location associated with a point of interest location; and
when the second location is greater than a proximate distance of the third location, preventing a receipt of audio data from the second mobile device, based at least in part on the proximate distance.
